(19) United States
(12) Patent Application Publication
(10) Pub. No.: US 2002/0162287 A1
(43) Pub. Date: Nov. 7, 2002

(54) Construction element for temporarily closing an opening in a wall in a building being constructed

(76) Inventors: Claus Bork, Birkerod (DK); Mads Blom, Hedehusene (DK)

Correspondence Address: WINSTON & STRAWN, PATENT DEPARTMENT, 1400 L STREET, N.W., WASHINGTON, DC, 20005-3502, US

(21) Appl. No.: 10/176,468

(22) Filed: Jun. 20, 2002

Related U.S. Application Data
(63) Continuation of application No. PCT/DK00/00677, filed on Dec. 7, 2000.

(30) Foreign Application Priority Data
Dec. 23, 1999 (DK) PA 1999 01859

(51) Int. Cl. E06B 3/26; E06B 3/00

(52) U.S. Cl. 52/202; 52/208

(57) ABSTRACT

A building closure for temporarily closing a bare opening in a wall in a building under construction or renovation. The building closure includes a closure frame made up of a number of bars and defining an opening mainly congruent with the wall opening, a plastic sheeting fastened on the closure frame and spanning its opening, and fastening members for fastening the closure frame to one side of the wall in an area around the wall opening. Each of the bars of the closure frame is V-shaped, has a first part mainly at right angles to the plane of the window and defining the closure frame opening, and a second part mainly at right angles to the first part and defining the periphery of the closure frame. The closure according to the invention can cover a bare wall opening in a building under construction or renovation in a less expensive, easier and tighter manner than known so far, with the two parts of the closure frame closing tightly maintained around the edge of the wall opening.

### CROSS-REFERENCE TO RELATED APPLICATIONS

This application is a continuation of International application PCT/DK00/00677 filed Dec. 7, 2000, the entire content of which is expressly incorporated herein by reference thereto.

### BACKGROUND ART

The invention relates to a closure for temporarily closing an opening in wall in e.g. a building under construction or renovation.

During the construction or renovation of many buildings, there will normally be wall openings that temporarily are bare and that only later will be mounted with e.g. windows or doors.

Traditionally, such bare wall openings are temporarily closed by means of wood laths that are joined together to form frames that each have an opening which is closed by an attached plastic sheeting.

Such a frame of wood laths with attached plastic sheeting is not especially tight in itself, and usually it furthermore fits the respective wall opening badly so that a larger or smaller gap is left between the sides of this wall opening and the frame of wood laths.

These gaps can be made tight with pointing which however is a labor-consuming and expensive operation which therefore often is skipped.

The result is that the above traditional solution for, by means of wood laths temporarily, closing bare wall openings is not to a satisfactory extent able to meet the demands that are today made on the environment in a building under construction or renovation.

The leaks can thus result in water damage to the building and the need for subsequent drying of damp-damaged sections in the building. There are furthermore, especially during the winter term, an expensive loss of heat and draught nuisances that can be health hazardous and cause increased sickness or work absences among the workers.

Obviously, it is possible to close bare wall openings by means of conventional doors or windows and relating frames. In practice, however, it is not possible to make a rough wall opening with very close tolerances. Instead, the wall opening is made with an overmeasure that allows a conventional frame being inserted and mounted in the opening. Thus, a larger or smaller gap is formed between the frame and the wall opening, and this gap must necessarily be pointed with an appropriate filler if the wall opening is to be closed with the desired tightness.

It is therefore an expensive and labor-consuming process to close a rough wall opening temporarily in the above conventional way. In the construction phase and at removal of the temporary closing, the applied doors or windows and relating frames will furthermore be very open to being damaged with consequent loss of materials.

### SUMMARY OF THE INVENTION

The invention provides a closure temporarily can close a bare wall opening in a building under construction or renovation in a less expensive, easier and tighter manner than hitherto known.

This closure comprises a closure frame for detachable mounting in a wall opening, a first plate-shaped part made on the closure frame and extending, in the mounted state of this closure frame, in along the inside face of the wall opening at a distance from this wall opening, a second plate-shaped part made on the closure frame and, in the mounted state of this closure frame, extending outward along one side of the wall, at least one cover for mounting on the closure frame, and means for fastening the closure frame in the opening.

When on the first part of the closure frame, at least one flap that is elastically bendable in a crosswise direction is located so that it extends along the exterior of the part and having, in unloaded state, a height greater than the gap between the exterior and inside faces of the wall opening, the closure according to the invention can be mounted in the wall opening quickly and easily. During this installation, the flap provides the necessary proofing of the gap between the frame and the rough wall opening without an extra contribution of labor and costs. At the same time, the flap advantageously centers the frame in the wall opening.

### BRIEF DESCRIPTION OF THE DRAWINGS

The invention will be explained in greater detail below, describing only exemplary embodiments with reference to the drawing, in which

FIG. 1 is a front fractional view of a wall with an opening temporarily tightly closed by a closure according to the invention;

FIG. 2 is a sectional view taken along the line II-II of FIG. 1;

FIG. 3 is on a larger scale a fractional sectional view of a first embodiment of a closure according to the invention in free position;

FIG. 4 is the same in mounted position on the wall in FIGS. 1 and 2;

FIG. 5 is on a larger scale a fractional sectional view of a second embodiment of a closure according to the invention in free position;

FIG. 6 is the same in mounted position on the wall in FIGS. 1 and 2;

FIG. 7 is on a larger scale a fractional sectional view of a third embodiment of a closure according to the invention in free position;

FIG. 8 is the same in mounted position of the wall in FIGS. 1 and 2;

FIG. 9 is on a larger scale a fractional sectional view of a fourth embodiment of a closure according to the invention in free position;

FIG. 10 is the same in mounted position on the wall in FIGS. 1 and 2;

FIG. 11 is on a larger scale a fractional sectional view of the wall in FIGS. 1 and 2 with a fifth embodiment of a closure according to the invention in mounted position;

FIG. 12 is the same seen from the inside face of the wall;

FIG. 13 is on a larger scale a fractional sectional view of a sixth embodiment of a closure according to the invention in free position;

FIG. 14 is the same in mounted position on the wall in FIGS. 1 and 2;

FIG. 15 is a perspective view of the wall in FIGS. 1 and 2;

FIG. 16 is a view of the wall in FIG. 15 but mounted with the closure in FIGS. 1 and 2;

FIG. 17 is a view of the wall in FIG. 15 but with a face wall under construction on the exterior of the wall;

FIG. 18 is a view of the wall in FIG. 17 but with the complete face wall ready for mounting of proper closure;

FIG. 19 is on a larger scale a fractional sectional view of the wall in FIGS. 1 and 2 with a seventh embodiment of a closure according to the invention in mounted position;

FIG. 20 is on a larger scale a fractional sectional view of the wall in FIGS. 1 and 2 with an eight embodiment of a closure according to the invention in mounted position;

FIG. 21 is on a larger scale a fractional sectional view of the wall in FIGS. 1 and 2 with a ninth embodiment of a closure according to the invention in mounted position;

FIG. 22 shows the closure according to the invention in a first mounting stage;

FIG. 23 shows the closure according to the invention in a second mounting stage;

FIG. 24 shows the closure according to the invention in a third mounting stage;

FIG. 25 shows the closure according to the invention in a fourth mounting stage;

FIG. 26 shows the closure according to the invention in a fifth mounting stage;

FIG. 27 is on a larger scale a fractional sectional view of the wall in FIGS. 1 and 2 with a tenth embodiment of a closure according to the invention in mounted position; and

FIG. 28 is on a larger scale a fractional sectional view of the wall in FIGS. 1 and 2 with an eleventh embodiment according to the invention in mounted position.

### DETAILED DESCRIPTION OF PREFERRED EMBODIMENTS

In order to easily be able to insert the closure frame in the wall opening, the elastically bendable flap on the first part of the closure frame can be arranged to incline crosswise in the direction of the second part. Thereby, the inside face of the wall opening will automatically bend the flap down during the insertion operation whereby the flap generates a spring power which forces its free edge area into close contact with the inside face of the opening.

The free edge area of the flap can furthermore be designed with a bend to ensure that the flap will not resist when the frame is pulled out of the wall opening at removal of the closure.

The closure can for example be fastened in the wall opening by means of screws or similar fastening means.

In an especially advantageous embodiment, the closure is however fastened by means of longitudinal barbs made on the inside face of the first part and in the mounted position of the window, forced in towards the inside face of the wall opening with the points facing obliquely out towards the side of the wall on which the closure is mounted. At mounting the closure is then quite simply pushed in place in the wall opening after which the barbs ensure the closure against unintentionally being pushed out of the opening due to e.g. the action of the wind.

Alternatively, the first part can have a longitudinal catch which in the mounted position of the closure, is extending behind the back of the wall and thereby effectively secures the closure in the wall opening.

In a second embodiment, the closure can be fastened in the wall opening by means of mounted straps/clips which are provided with barbs and drawn through openings in cross members resting against the other side of the wall.

In a variant of this embodiment, the cross members can jointly consist of a support frame with mounted straps each having a fork with barbs that, in the mounted position of the closure, lockingly engage with a corresponding barb on the closure frame of the closure.

The above mounting forms of the closure all have the advantage that the closure can be mounted in the wall opening quickly, easily and conveniently without during this having to use tools or other kinds of aids.

The cover that fills the opening in the closure frame of the closure can advantageously be a flexible cloth which advantageously can consist of one or several layers of transparent plastic sheeting of e.g. polyethylene.

Such a sheeting allows daylight to penetrate into the building so that the need for artificial lighting is eliminated or at least reduced for a large part of the year.

The sheeting can furthermore be reinforced with filaments for giving the sheeting the necessary strength to be able to resist the often considerable wind and mechanical actions to which it is subjected in practice.

The flexible cloth can be mounted on the closure frame quickly, securely and easily when the closure comprises a clamping frame consisting of a number of loose or joined rods and serving for fixing the cloth on the closure frame.

In an advantageous embodiment the clamping frame—from a cross-sectional view—can be designed as a U while longitudinal grooves can be made in the closure frame for receiving the ends of the legs of the U which thus can squeeze the peripheral area of the flexible cloth together between the legs of the U and the grooves. This fixing can e.g. take place by means of screws.

In a second advantageous embodiment the clamping frame can have a contact face and the closure frame a second contact face shaped complementarily for fastening a flexible cloth.

In this embodiment the clamping frame can, as an example, be arranged to hold two flexible cloths at a mutual distance and fix both cloths between the two contact faces.

For this purpose the closure can have a number of clamps arranged to be fastened on the closure frame and clamp the clamping frame in against the contact face of the closure frame.

Each clamp can advantageously be designed as a chair with legs for being pressed in grooves shaped complementarily in the first part of the closure frame, a back for bearing against the clamping frame, and a seat for absorbing a pressure for pressing the legs of the chair in the grooves shaped complementarily in the first part of the closure frame.

In the summer and under warmer skies a cover with only one cloth will be adequate. When it is cold, two cloths can advantageously be used for the cover, thereby saving considerable expenses for heating the respective building.

In order to obtain great insulating power and a corresponding great cost saving the clamping frame must be arranged to keep the two flexible cloths at a good distance from each other. For this purpose the clamping frame can advantageously be made of a pipe which, with an economically small material consumption, can have a large diameter.

The pipe can e.g. be round or rectangular. In the latter case, the contact face of the closure frame can include the inside face of a groove made in the closure frame, and the contact face of the pipe can consist of the outer side on a projection shaped complementarily of the rectangular pipe. By means of this solution, a considerable advantage is obtained in that the clamping frame and the closure frame reinforce each other, and that they therefore both can be made with a modest consumption of materials.

With a view to prevent wind, rain and snow from penetrating in behind the closure, a gap with a sealing ring can be arranged between the second part of the closure and the side of the wall.

On the first part of the closure can furthermore be made a handle for manually drawing the closure frame into the wall opening from the inside face of the wall. Then, the closure frame can be screwed into the wall opening.

The above-mentioned flaps on the first plate-shaped part of the closure frame can in a simple embodiment be replaced by one or several lists of an elastically deformable material such as rubber.

In a second embodiment the flaps can be individual elements consisting of e.g. plastic and mounted on the first plate-shaped part.

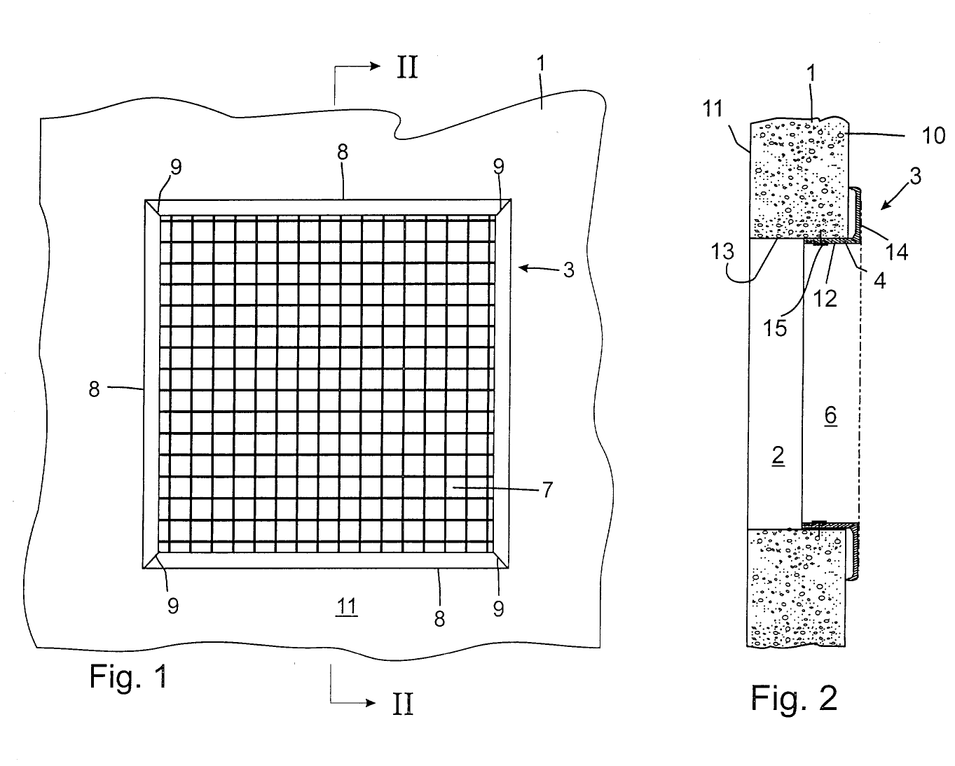

FIGS. 1 and 2 are fractional views of a wall 1 with a quadrangular wall opening 2. In the example shown it is assumed that the wall opening 2 is intended for a window in a building under construction, and that the construction has not yet come so far that the associated window has been mounted in the hollowed wall opening.

In order to avoid heat loss until then, protect the incomplete building against the weather and provide an indoor climate suitable for drying the building, the wall opening 2 is tightly closed with a window 3 according the invention.

This window mainly consists of a window frame 4 and a cover of a plastic sheeting 5 fastened on the window frame and spanning the opening 6 defined by the window frame.

The window frame 4 is just as the wall opening 2 quadrangular and the opening 6 is congruent with the opening 2 of the wall.

In this case the plastic sheeting is transparent so that the sheeting in the same way as the glass in a window allows daylight to penetrate into the building and thereby reduce or render superfluous artificial lighting for a large part of the year.

The plastic sheeting is furthermore of the type that is flexible and that is reinforced with filaments 7 to give the sheeting the necessary strength to resist wind loads and mechanical actions to which the sheeting might be subjected during construction.

The reinforcing filaments can e.g. be extending parallel to the sides of the opening or diagonally in relation to these sides. In the last case, the filaments will contribute considerably to increase the stability of the window frame.

The sheeting can in itself be made of any kind of suitable plastic but is especially made of polyethylene.

In this case the window frame consists of four V-shaped bars 8 abutting on each other and welded together in the corners 9 of the window frame. The bars can be made of any kind of suitable material, for example aluminium or steel, but consists especially of extruded plastic bars that advantageously can be made with a cross section suited for solving the proposed task by being able to close the bare wall opening in a satisfactorily tight way.

The plastic that is used for making the bars can advantageously be polyethylene which, by means of relatively simple tools, can be melted together in the areas where the bars of the window frame are abutting on each other and are to be joined.

The window 3 is located on the front 10 of the wall while the back 11 of the wall is free in this case. The window frame has a first part 12 extending in along the inside face 13 of the wall opening 2, and a second part 14 extending along the front 10 of the wall 1. By means of screws 15 or similar fastening means, the first part 12 of the window frame and thereby the window 3 is fastened on the inside face 13 of the wall opening.

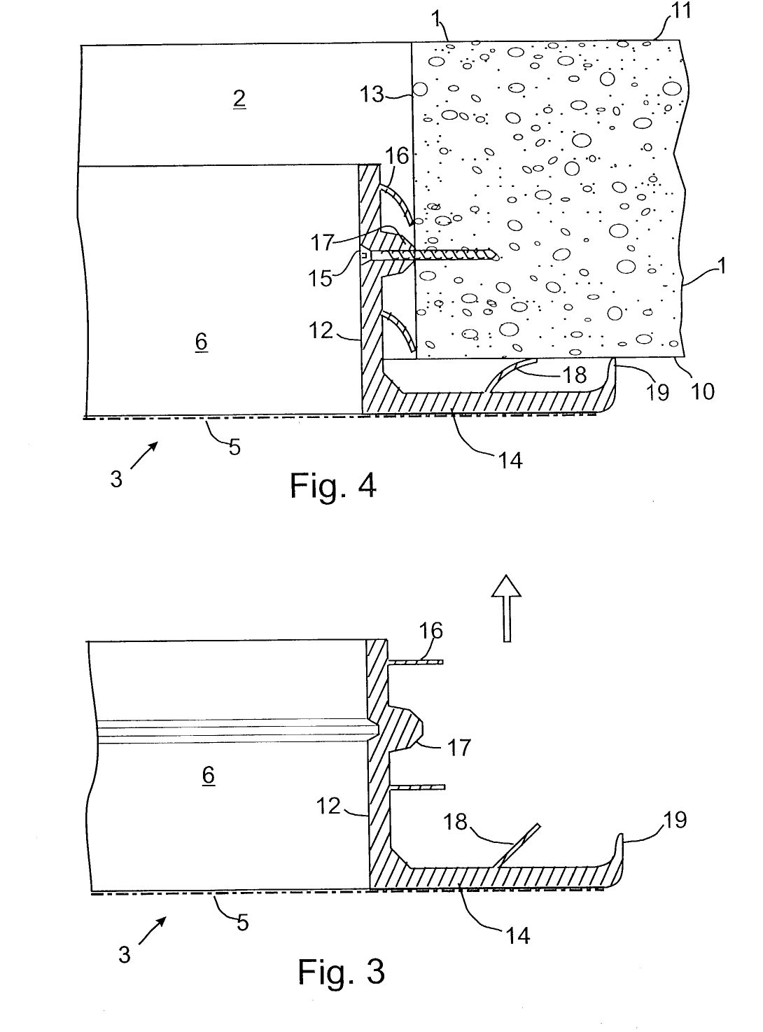

FIGS. 3 and 4 are on a larger scale fractional views in detail of how the window in FIGS. 1 and 2 is arranged and functions.

As can be seen, the first part 12 of the window frame 4 is provided with two longitudinal sealing lips 16 and a longitudinal, rigid rib 17 on the inside of the V that the two parts 12 and 14 form with each other. The sealing lips 16 are a little higher than the rib 17.

On the inside face of the second part 14 is made a longitudinal, oblique sealing lip 18 and the second part furthermore has a longitudinal cog 19 along the periphery.

At mounting the window is guided in the direction indicated by the arrow from the free position in FIG. 3 to the mounted position in FIG. 4.

During this the sealing lips 16 of the first part are bent elastically and will thereby effectively create a sealing with the inside face 13 of the wall opening 2.

The window is fastened by means of e.g. screws 15 put through the rigid rib 17 of the first part. When the screws are tightened, the rib 17 will hit the inside face 13 of the wall opening. Thereby, the sealing lips are secured against being bent so much that they are inflicted with permanent deformations and no longer effectively would be able to create a sealing with the inside face of the wall opening.

The oblique sealing lip 18 on the second part 14 is creating a corresponding sealing with the face 10 of the wall while the cog 19 determines the distance to the face and is creating a jointless conclusion against the wall.

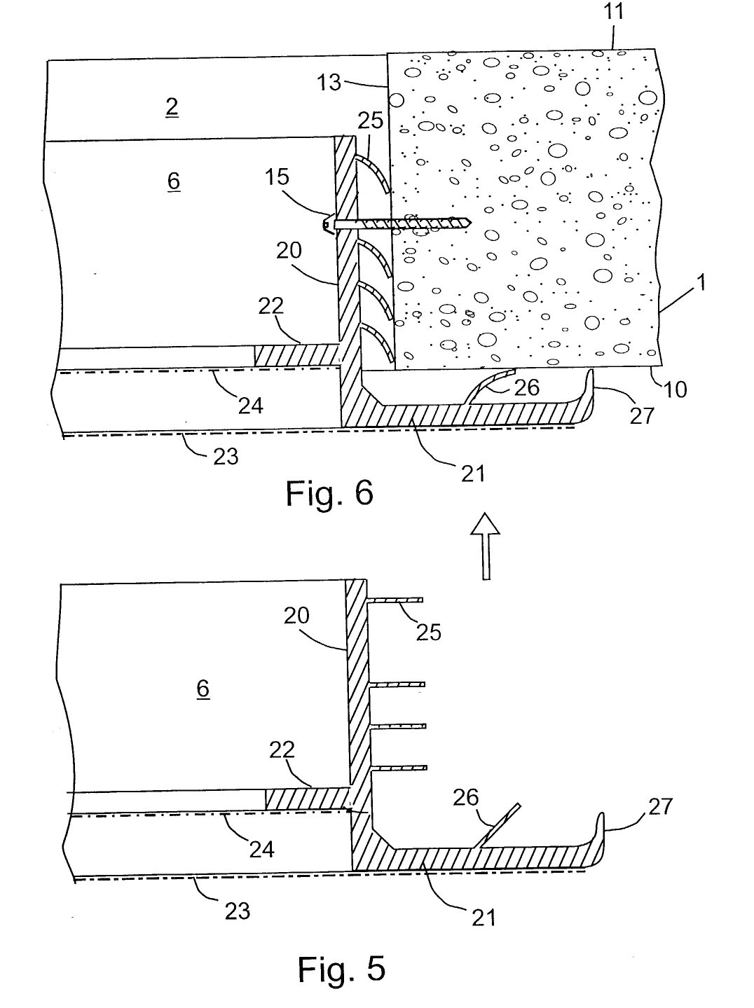

FIGS. 5 and 6 show a second embodiment of a window frame for a window according to the invention. The window frame has a first part 20 and a second part 21. At a distance from the outer side of the second part 21, a longitudinal rib 22 is made on the first part 20, said rib faces inwards in the opening 6 of the window frame.

In this case, the glass pane of the window consists of a first plastic sheeting 23 fastened on the second part 21 and a second plastic sheeting 24 fastened on the rib 22. The two plastic sheetings 23 and 24 together form an effective double pane unit that makes the window suitable for use during cold periods, for example during the winter term.

On the first part 20 are made four longitudinal sealing lips 25 and on the second part 21 a longitudinal, oblique sealing lip 26 and a longitudinal cog 27.

At mounting the window is guided in the direction indicated by the arrow from the free position in FIG. 5 to the mounted position in FIG. 6 in which the window is moreover functioning in the same way as described with reference to FIGS. 3 and 4.

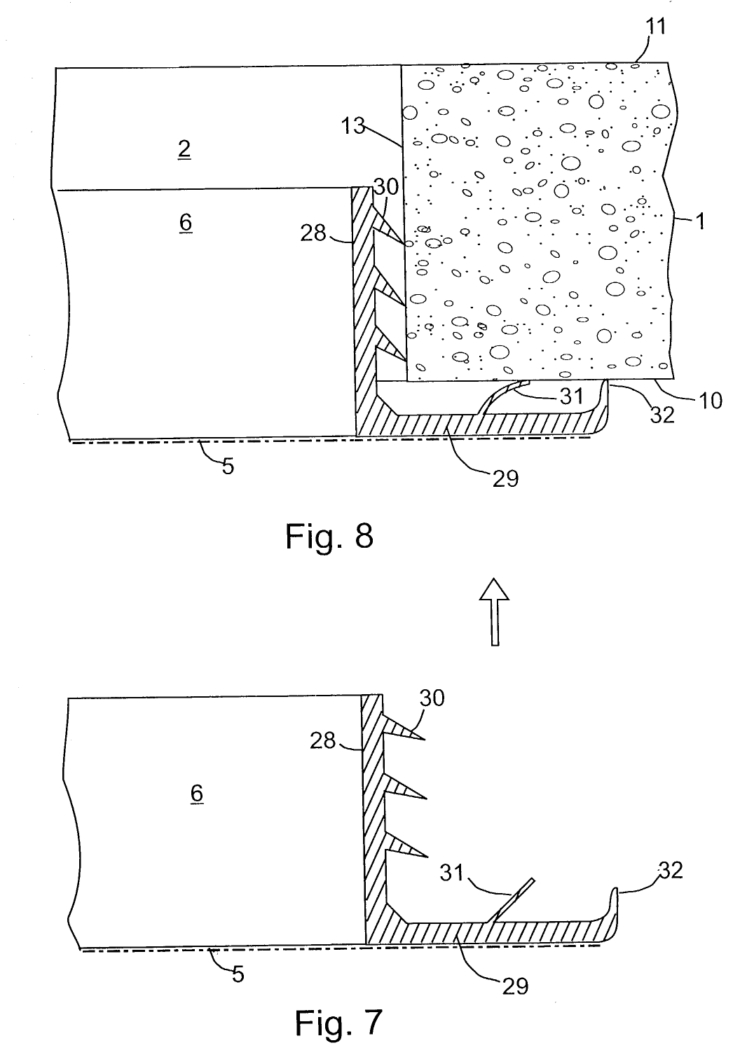

FIGS. 7 and 8 show a third embodiment of a window frame for a window according to the invention. The window frame has a first part 28 and a second part 29.

Three longitudinal barbs 30 are made on the first part 28 and on the second part 29 a longitudinal, oblique sealing lip 31 and a longitudinal cog 32.

When the window is guided in the direction of the arrow from the free position in FIG. 7 to the mounted position in FIG. 8, the barbs 30 are bent while overcoming the spring power in the barbs and are thereby forced in towards the inside face 13 of the wall opening with the points facing in the opposite direction of the direction of insertion so that the barbs will keep the window frame and thereby the window fixed in the wall opening. At the same time, the barbs function as sealing lips.

In mounted position, the window is moreover functioning in the same way as described with reference to FIGS. 3 and 4.

The third embodiment of the window can be mounted quickly and easily by merely pushing the window into the respective wall opening. It is therefore suited for closing especially smaller openings and in the cases where the window is kept clear of larger loads.

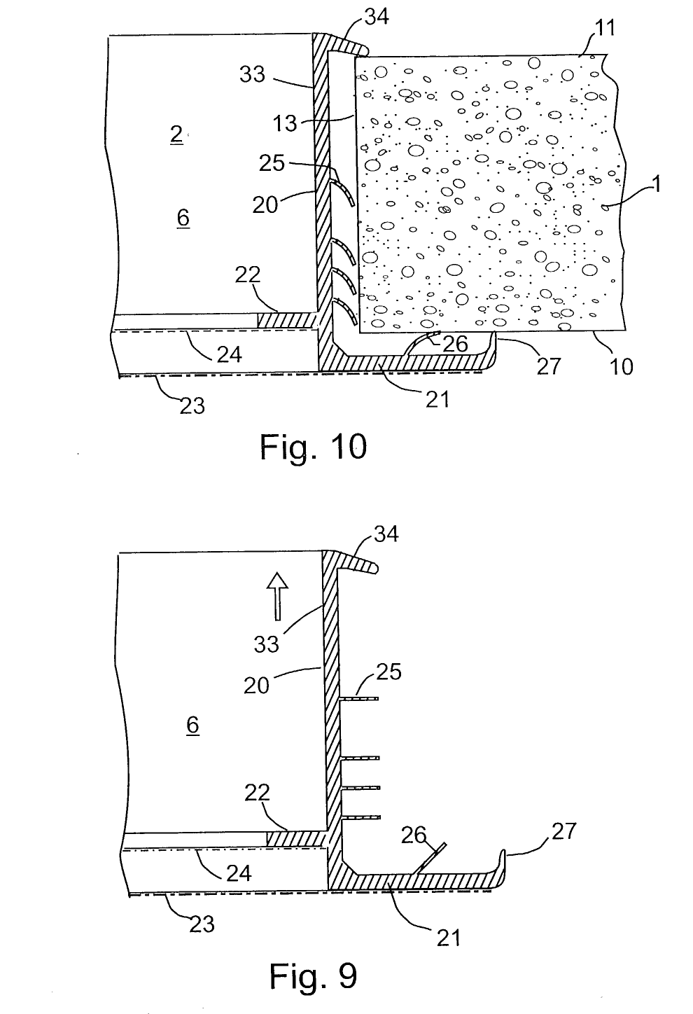

FIGS. 9 and 10 show a fourth embodiment of a window according to the invention. This window corresponds mainly to the window in FIGS. 5 and 6, and like components are thus similarly referenced.

In this case the first part 20 of the window frame however has an extension 33 ending in a longitudinal catch 34 facing in the same direction as the second part 21, that is outwards in the window frame.

When the window is guided in the direction of the arrow from the free position in FIG. 9 to the mounted position in FIG. 10, the first part 20 is bent inwards in the wall opening while the longitudinal catch 34 is sliding along the inside face 13 of the wall opening until it has reached through the opening and elastically snaps in behind the back 11 of the wall where it is securely detaining the window against being pulled free of the opening again under the action of external forces, such as wind loads.

In mounted position the window is moreover functioning in the same way as described with reference to FIGS. 5 and 6, it must however be noted that in this case screws are not needed to fasten the window in the wall opening.

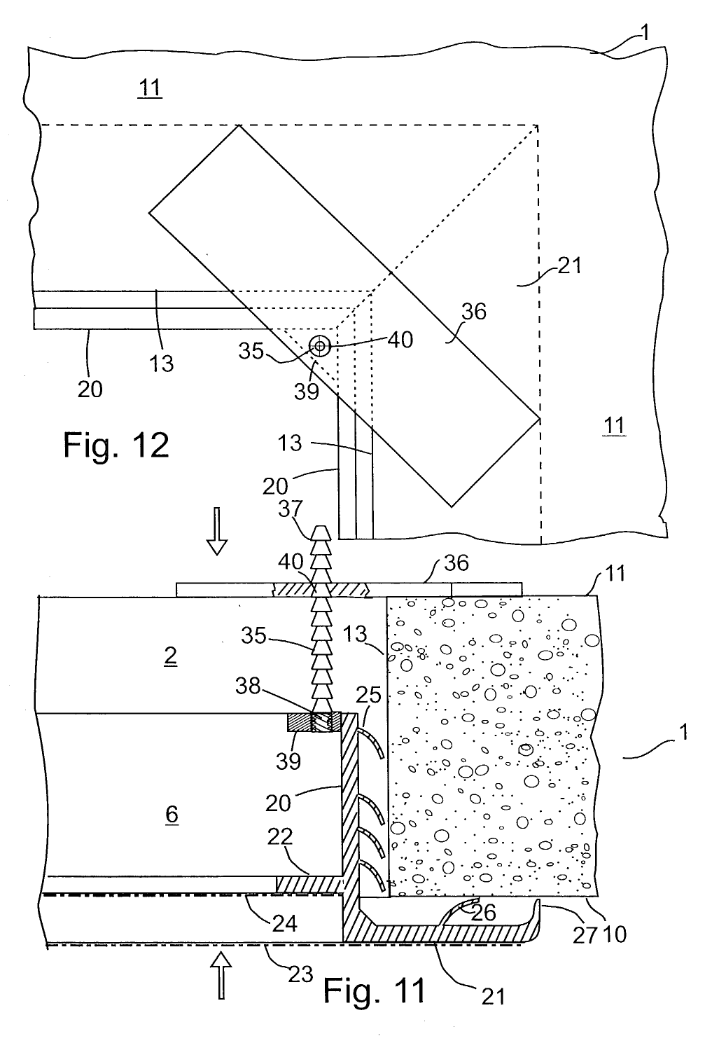

FIGS. 11 and 12 show a fifth embodiment of a window which in the main corresponds to the window in FIGS. 5 and 6. Like components are thus similarly referenced.

In mounted position the window is moreover functioning in the same way as described with reference to FIGS. 5 and 6, it must however be noted that neither in this case are screws needed to fasten the window in the wall opening.

Instead the window frame is effectively fastened by means of a number of straps 35 mounted on the window frame of the window and a number of associated cross members 36 on the back of the wall.

In FIG. 11 is seen such a strap which, in the case shown, is shaped as a tension string 35 extending upwards from the window frame and provided with a number of barbs 37 having points pointing in the direction from the first side of the wall to the second.

The tension string 35 is, by means of a thread joint 38, screwed into a nut 39 welded onto the upper corner between two window frame bars.

FIG. 12 shows the back of the wall and as can be seen, the cross member 36 is placed across a corner between two of the adjacent sides 13 of the wall opening. In the cross member is a through hole 40 matching the tension string 35. The hole is conic and tapers in the same direction as the barbs of the tension string.

At mounting of the window the tension strings 35 are first screwed into the nuts 39 on the first part 20 of the window frame. Then, the window and the cross members 36 are guided in towards each other in the direction indicated by the arrow so that the tension strings are pushed through the conic holes 40 of the cross members until the cross members 36 are bearing against the back of the wall and the second part 21 of the window frame is bearing against the front of the wall.

The window is now securely fastened in the wall opening, because the barbs 37 of each tension string will hit the peripheral area around the conic hole 40 on the back of the associated cross member 36 if the window and the cross members are subjected to stresses in the opposite direction of the arrows. Thereby, the window and the cross members are effectively kept in locking engagement with each other.

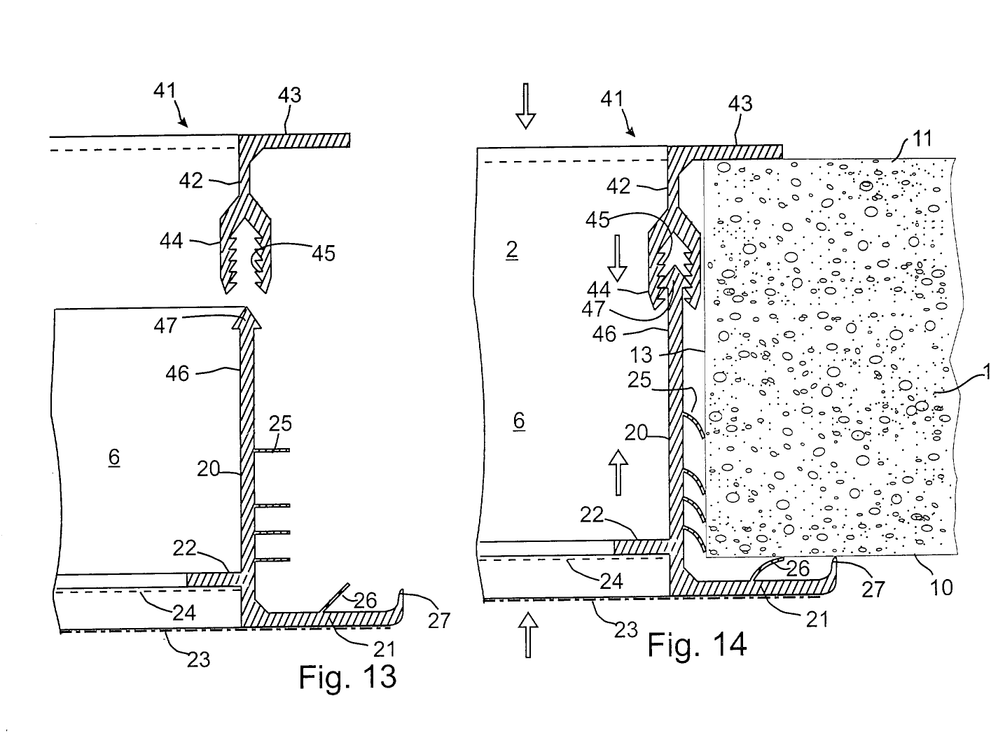

FIGS. 13 and 14 show a sixth embodiment of a window that mainly corresponds to the window in FIGS. 5 and 6. Like components are thus similarly referenced.

In mounted position the window is functioning in the same way as described with reference to FIGS. 5 and 6, it must however be noted that screws are not needed to fasten the window which instead is fastened in the wall opening by means of a separate support frame 41 resting against the back 11 of the wall.

The support frame 41 has a first part 42 extending into the wall opening 2, and a second part 43 extending along the back 11 of the wall 1. On the first part is placed a number of forks 44 with two opposite rows of barbs 45. Alternatively, the entire outermost end portion of the part can be forked.

The first part 20 of the window frame has an extension 46 ending in a longitudinal barb 47 pointing in the direction from the front of the wall to the back.

At mounting the window frame of the window and the support frame are guided in towards each other in the direction indicated by the arrow whereby the barb 47 on the first part 20 on the window frame of the window is pushed into the fork 44 of the support frame 41 until the second part 43 on the support frame is bearing against the back 11 of the wall and the second part 21 on the window frame of the window is bearing against front 10 of the wall in the ready-mounted position of the window.

In this position the support frame and the window frame of the window are effectively keeping each other locked in the wall opening 2 by means of the engagement between the barb 47 on the first part 20 on the window frame of the window and the barbs 45 in the forks 44 on the first part 42 of the support frame.

It is to be noted that the above mounting arrangement alternatively can be arranged in such a way that the forks, on the contrary, are placed on the first part of the window frame of the window and the first part of the support frame has an extension ending in a longitudinal barb.

The embodiments shown in FIGS. 1-14 of the window according to the invention can easily be mounted from within the building, the respective window then being put mainly diagonally out through the wall opening, righted and pulled in towards the exterior of the wall after which the window is fastened in the ways described above and shown in the drawing. Thereby the need for having to use outside scaffolding or lifts is advantageously eliminated when the windows are to be mounted in the wall openings.

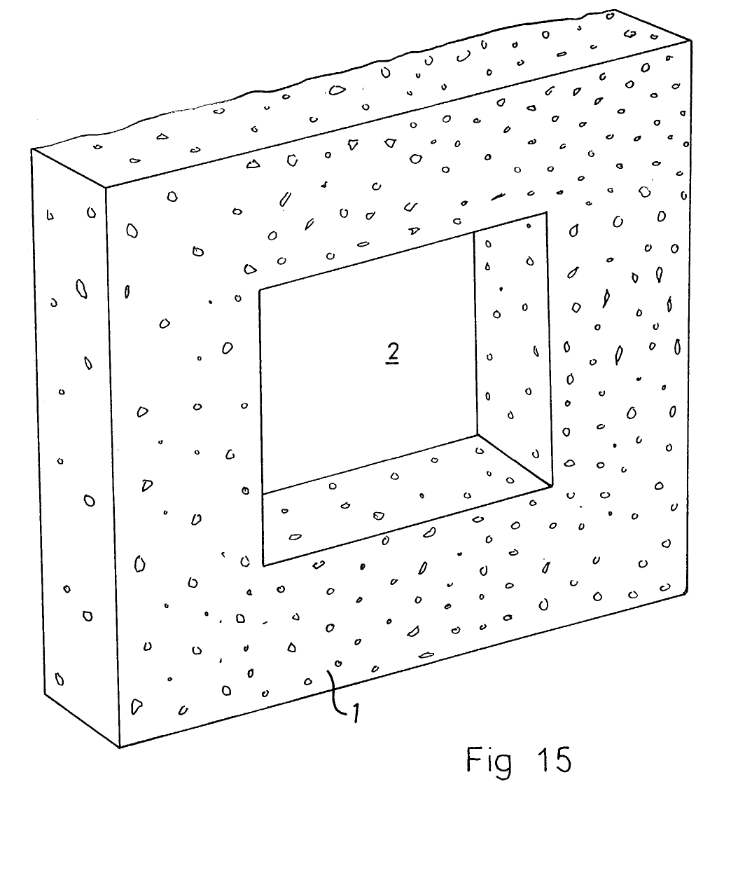

The thus mounted window can be removed quickly and easily when the proper windows are to be mounted. In some case it would be expedient to leave the window in the wall opening as illustrated in FIGS. 15-18.

FIG. 15 shows the wall 1 in FIGS. 1 and 2. In this wall is made a wall opening 2 for later mounting of a window.

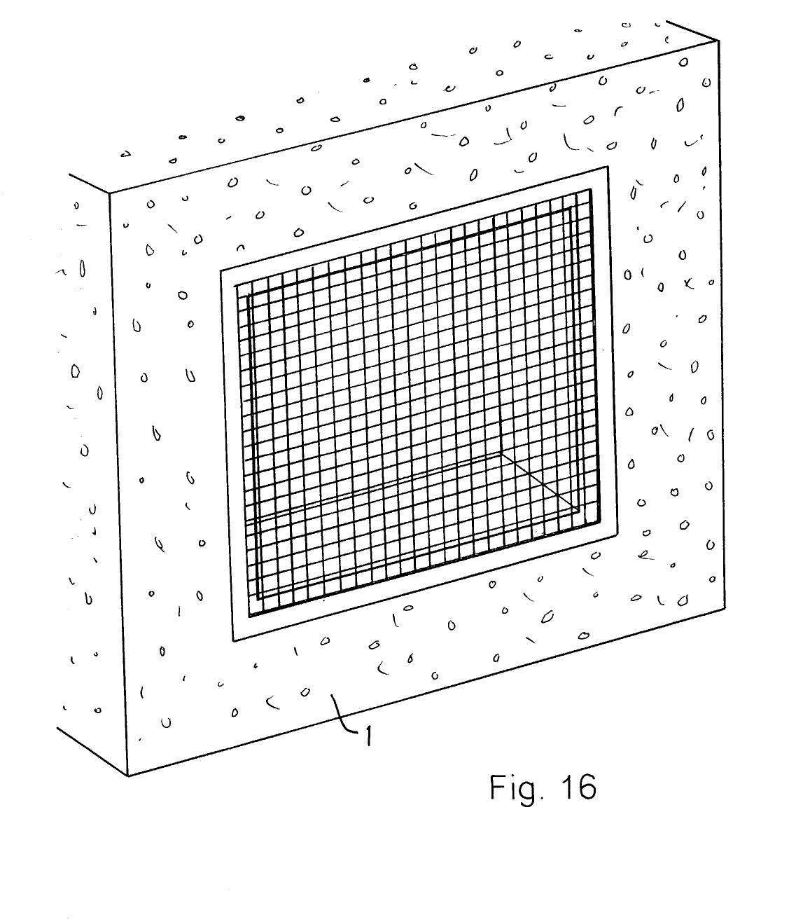

In FIG. 16 the building window 3 in FIGS. 1 and 2 is mounted in the wall opening. In the main, the window consists of a window frame 4 and a transparent plastic sheeting 5 functioning as cover in the opening 6 of the window frame. The plastic sheeting is reinforced by filaments 7.

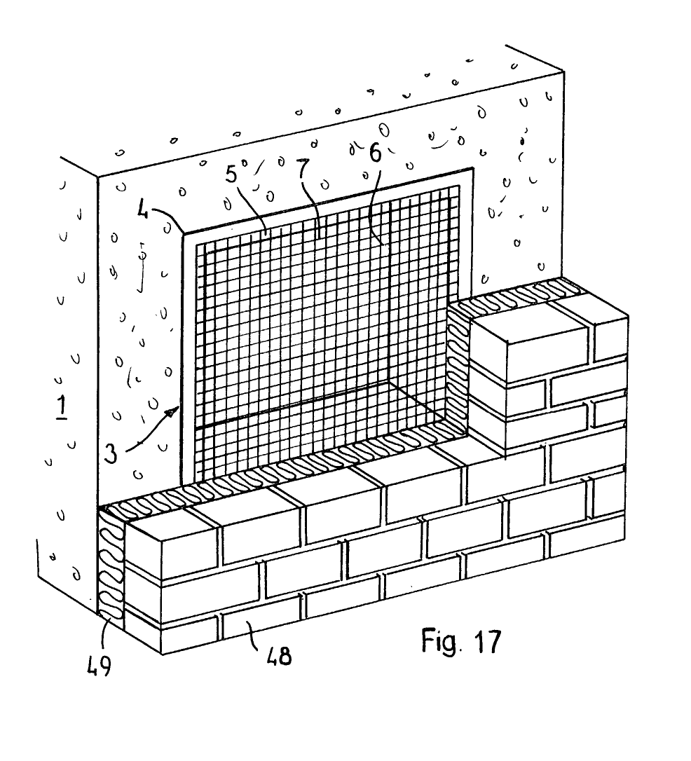

In FIG. 17 a face wall 48 is being built with an intermediate insulation 49 up around the wall opening 2 so that the window frame of the window is covered.

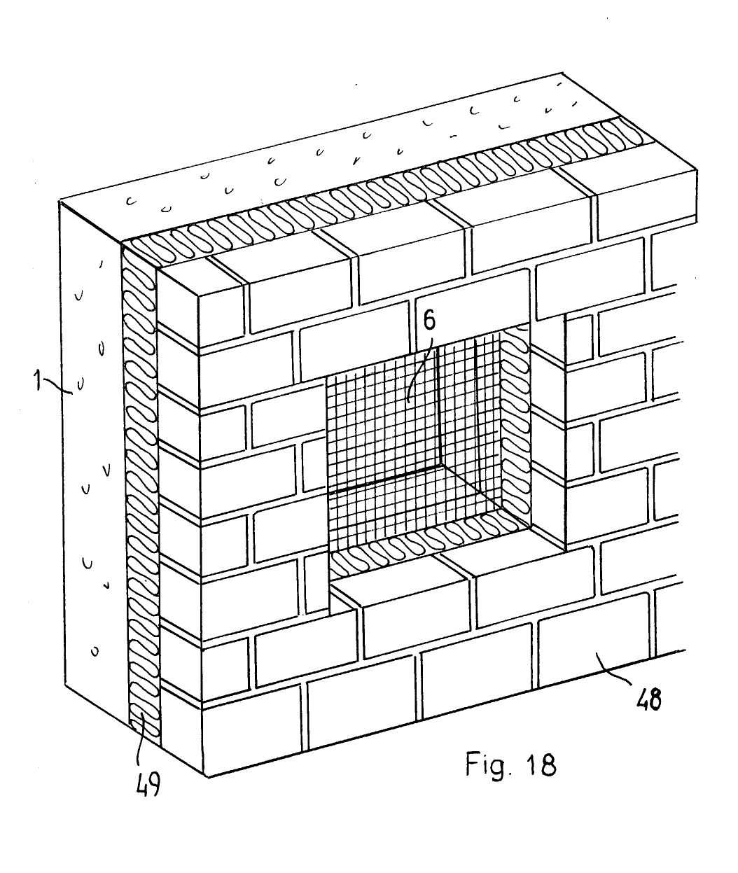

In FIG. 18 the face wall is completed and it is now only necessary to cut away the plastic sheeting in order to be able to mount the proper window.

In this case, the window was conveniently left in the wall opening in which it was mounted. In other cases it pays to remove the window and use it again at another place in the same or another building.

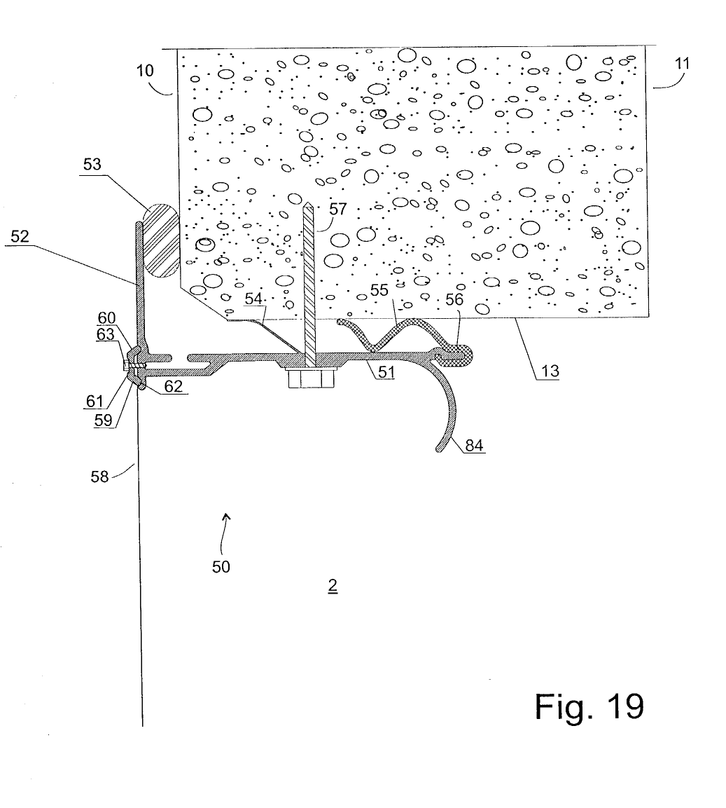

In FIG. 19 is shown a seventh embodiment of a window according to the invention. The window has a window frame 50 with a first part 51 extending in along the inside face 13 of the wall opening at a distance from this face, and a second part 52 extending along the face 10 of the wall at a distance from this face. The window frame can consist of a number of loose or joined bars.

Between the second part and the exterior of the wall is placed a sealing 53 for preventing wind, rain and snow from penetrating in behind the window. The sealing can be made of e.g. rubber, solid foam, or asphalt.

On the outer side of the first part 51 of the window frame 50 is placed a longitudinal, elastic flap 54 which can be in one piece with the first part or be an individual flap mounted on the first part. The flap is inclining in the direction of the second part 52 and will therefore automatically bend when the window frame is guided into the wall opening 2. Thereby, the flap is, with a free peripheral area, forced to bear tightly against the inside face 13 of the wall opening by means of the spring power generated in the flap at bending. At the same time the window frame is centred in the wall opening.

A sealing 55 mounted on a projection 56 facing backwards on the first part 51 of the window frame serves to further ensure the sealing between the window and the inside face of the wall opening and especially in towards the room behind the window.

As can be seen, the window frame 50 is screwed into the wall opening 2 by means of a number of assembly screws 57.

A flexible cloth 58 is fastened on the window frame by means of a clamping frame 59 which can consist of a number of loose of joined bars.

In this case, the clamping frame 59 is shaped as a U with two legs 60 and a bottom 61. In the window fame 50 are made a longitudinal grooves 62 for receiving the ends of the legs 60.

The cloth 58 is mounted on the window frame 50 by being squeezed into the grooves 62 by the ends on the legs 60 of the U, the clamping frame being fastened on the window frame by means of screws 63.

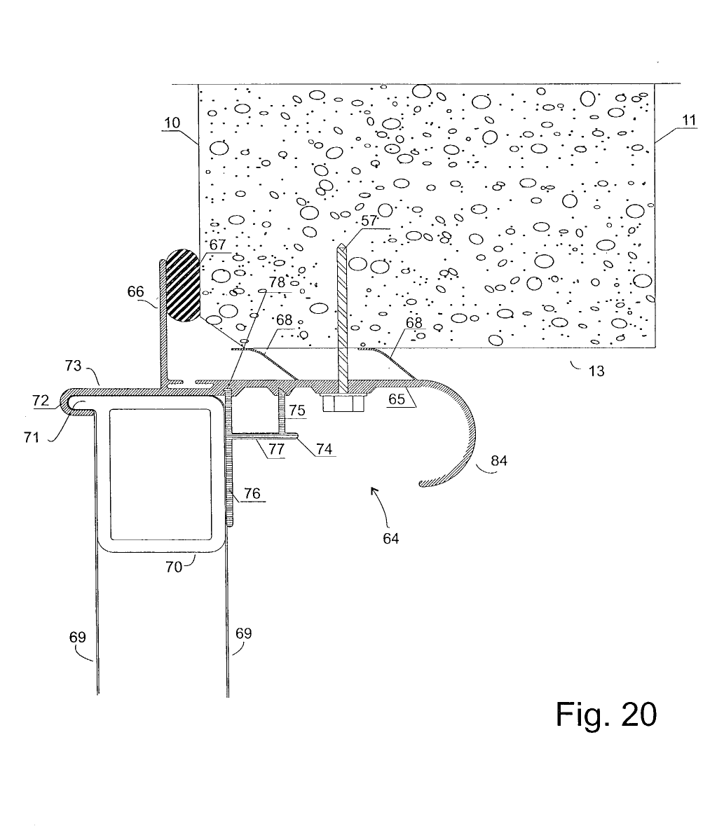

FIG. 20 shows an eight embodiment of a window according to the invention. The window has a window frame 64 with a first part 65 extending in along the inside face 13 of the wall opening 2 at a distance from this face, and a second part 66 extending along the face 10 of the wall at a distance from this face. The window frame can consist of a number of loose or joined bars.

Just as in the seventh embodiment, a sealing 67 is placed between the second part and the face of the wall for preventing wind, rain, and snow from penetrating in behind the window.

On the outer side of the first part 65 of the window frame 64 are made two longitudinal, elastic flaps 66 corresponding to the flap 54 of the seventh embodiment and functioning in the same way.

Two flexible cloths 69 are fastened on the window frame 64 by means of a rectangular, piped clamping frame 70 which can consist of a number of loose or joined bars.

On the clamping frame 70 is made a projection 71 and on the window frame 64 a second projection 72 having a groove 73 for receiving the projection 71 of the clamping frame. When the latter projection is engaging the groove 37 in the projection 72 of the window frame, the two frames 64 and 70 advantageously reinforce each other.

The two cloths 69 are fastened, as shown, on the window frame by means of the clamping frame 70.

As shown, a peripheral area on each of the two cloths 69 is squeezed together between the inside face of the groove 73 in the projection 72 of the window frame 64 and the projection 71 on the clamping frame 64.

The clamping frame is in itself fastened on the window frame by means of an adequate number of clamps 74 which in this case, each are shaped as a chair with two legs 75, a back 76 and a seat 77.

In the first part 65 of the window frame are furthermore made two grooves 78 for, at mounting, receiving the free ends of the legs 75 of the chair. This mounting takes place by pushing on the seat 77 of the chair whereby the legs 75 are squeezed into the grooves 78 and the back 76 is made to rest against the clamping frame with an intermediate part of the inner cloth.

To keep the legs 75 in the grooves 78, their free ends are hook-shaped while the grooves 78 have a shape complementary to these ends.

The clamps are made of an elastic material and are arranged to, in mounted position, affect the number of clamps with a spring power that is mainly effective in the direction towards the projection on the window frame.

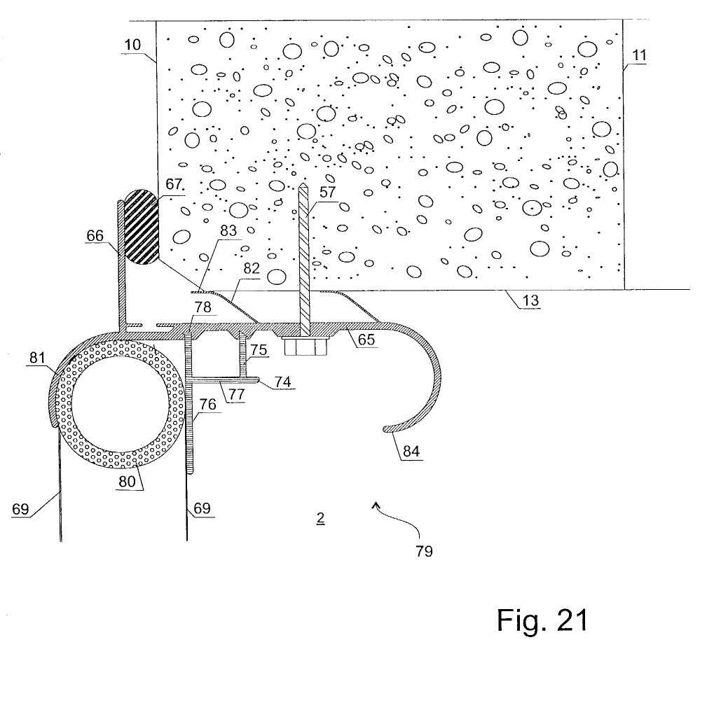

FIG. 21 shows a ninth embodiment 79 of a window according to the invention. This window mainly corresponds to the window 64 mentioned above and shown in FIG. 20. Like components are thus similarly referenced.

In this case, the clamping frame however consists of a round pipe 80 while on the window frame 79 is made a corresponding, complementarily arc-shaped projection 81.

In this case, the free peripheral area 83 of the flaps 82 on the first part 65 of the window frame is, as shown, shaped with a bend allowing the window 79 to unobstructedly be drawn out of the wall opening 2 after use.

On the first part 65 of the window frame is a handle 84 for use at mounting to manually draw the window frame into the wall opening from the inside of the wall. A corresponding handle 84 for the same purpose is on the in FIGS. 19 and 21 shown seventh and eight embodiment, respectively, of the window according to the invention.

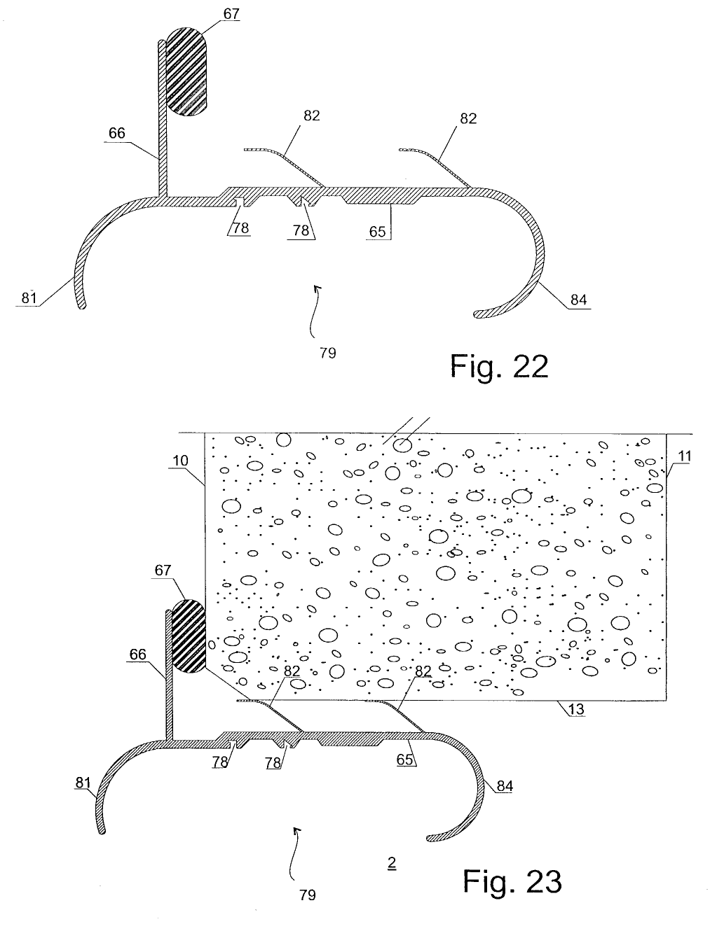

In the case of the window 79 in FIG. 21, mounting takes place as shown in FIGS. 22-26.

The window frame 79 consists of bars extruded of an appropriate material, for example aluminium, and preferably joined to an assembled frame in advance.

FIG. 22 is a cross-sectional view of the window frame 79 with mounted sealing 67.

In FIG. 23, the window frame is drawn into the wall opening 2 by a pull in the handle 84. During this, the sealing 67 is pressed tightly in against the face 10 of the wall and the flaps 82 have been bent and are now bearing closely against the inside of the wall opening with an edge area under the effect of the spring power in the bent flaps.

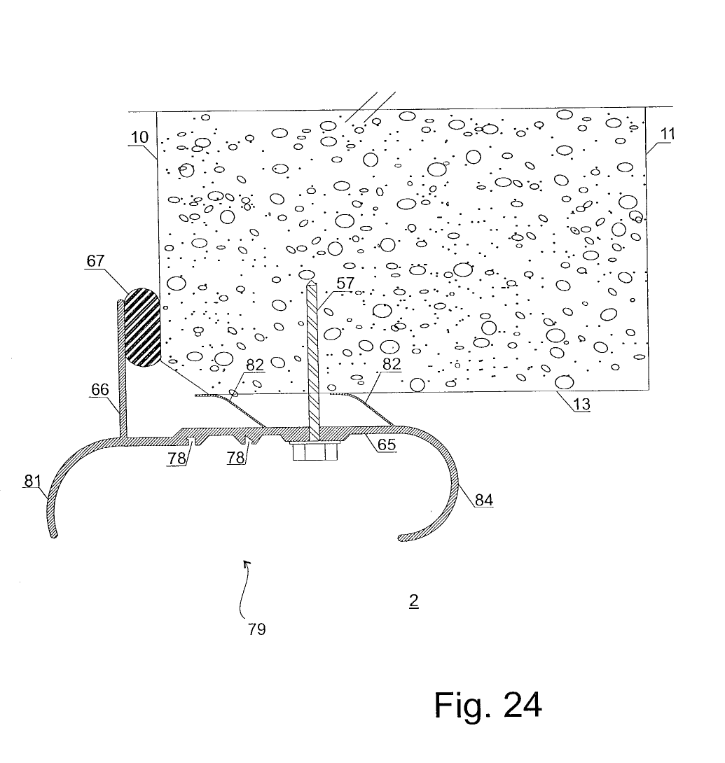

In FIG. 24, the window frame is screwed into the wall opening 2 in this position by means of screws 57.

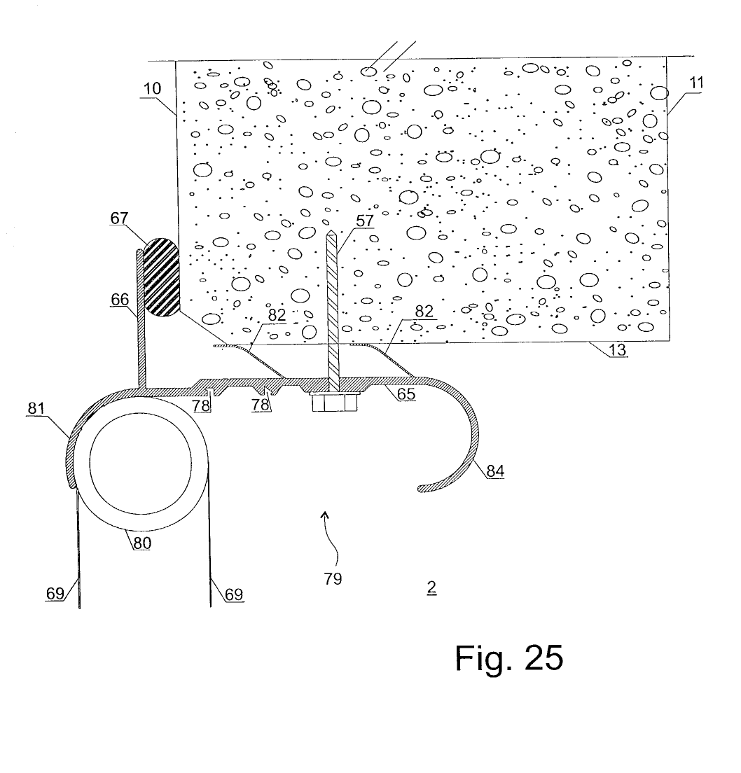

In FIG. 25, the clamping frame 80 is made to bear against the arc-shaped projection 81 on the window frame 79 with an intermediate peripheral area of the cloths 69.

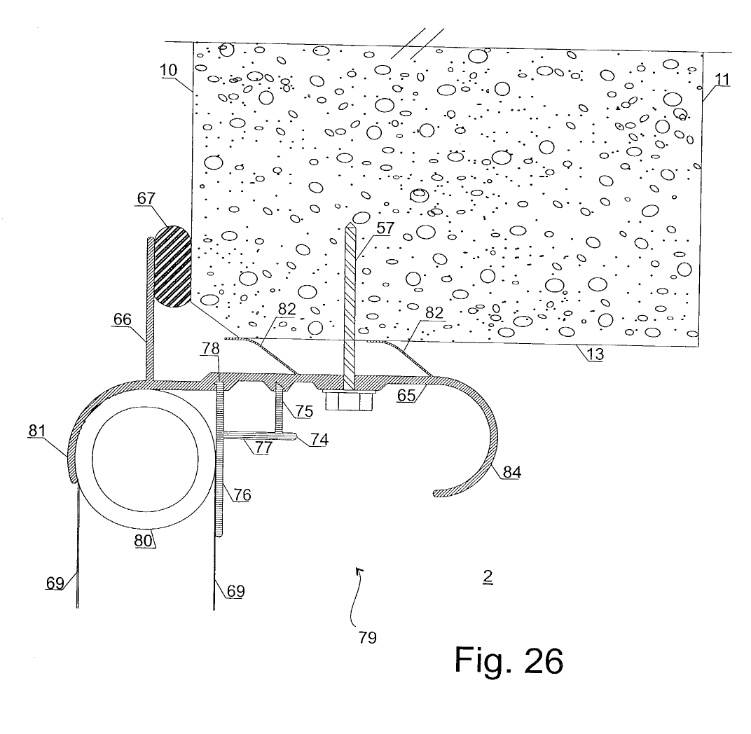

In FIG. 26, the legs 75 of the chair 74 are pressed into the longitudinal grooves 78 in the first part 65 of the window frame by means of a pressing on the seat 77. The back 76 of the chair is now fixing the clamp frame 80 towards the arc-shaped projection 81 of the window frame so that the cloths 69 are fastened in the window.

In this way, the window opening has temporarily been windowed quickly, easily and tightly by means of an inexpensive window that easily can be removed after used merely by loosening the screws 57.

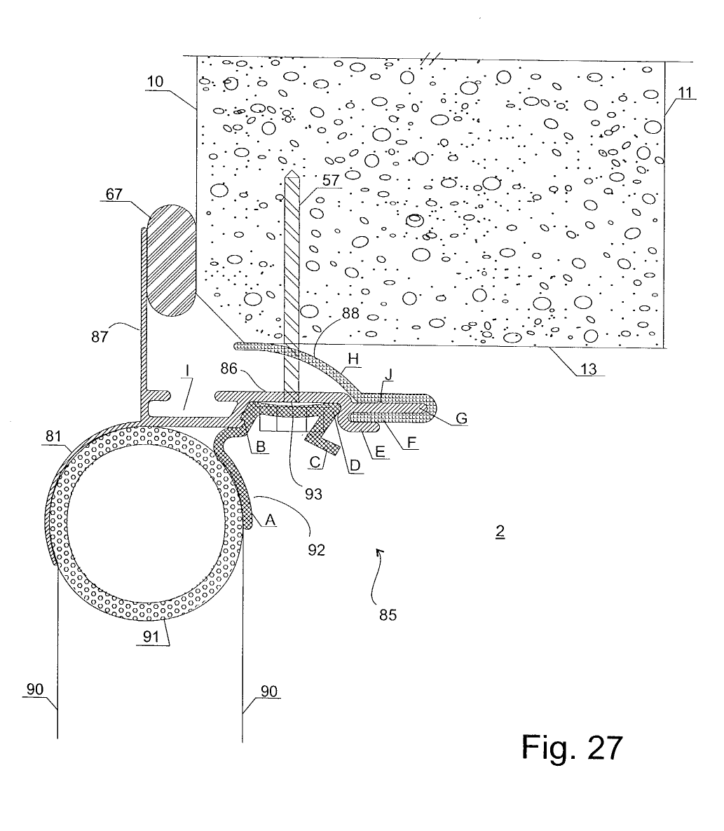

FIG. 27 shows a tenth embodiment of a window according to the invention.

In this case, an elastic sealing lip 88 is mounted on the first part 86 of the window frame 85, said lip is made of an elastic material such as plastic. The second part of the window frame is designated with the reference number 87.

The window furthermore comprises a clamping frame 89 consisting of a number of loose or joined pipes serving for fastening two flexible cloths 90 on the window frame by means of a number of clamps 91 which themselves are fastened in a groove 92 in the window frame.

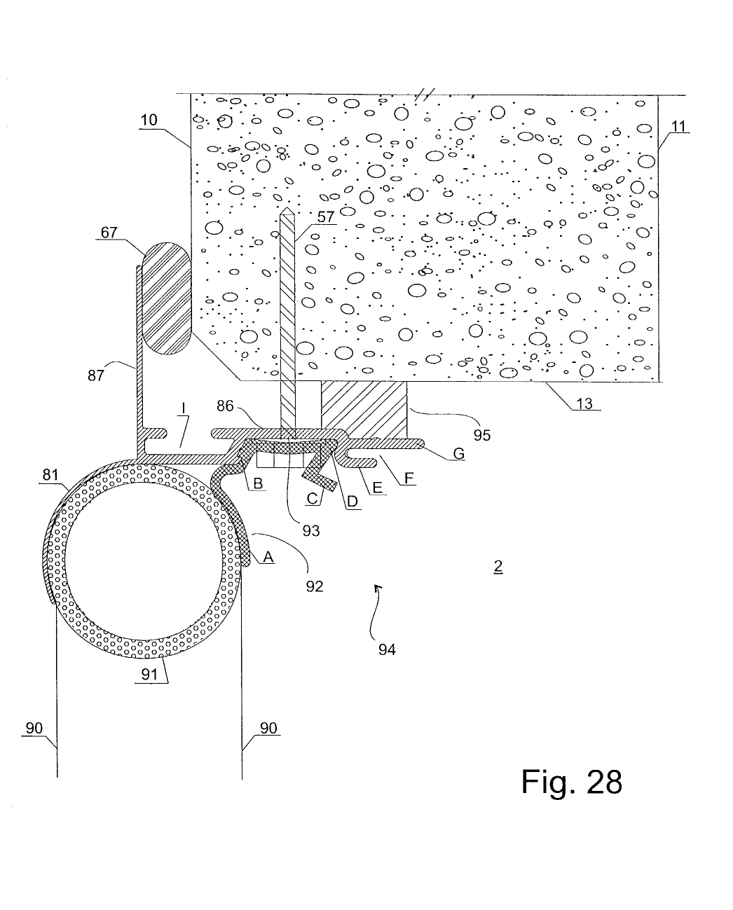

FIG. 28 shows an eleventh embodiment 93 of a window according to the invention. This embodiment corresponds to the one shown in FIG. 26 with the difference that a list 94 of an elastically compressible material, such as rubber, is used instead of an elastic sealing lip.

The windows are sometimes reused. As wall openings in buildings often are not designed in standard sizes, it will, in many cases, however not pay to store, catalogue, and distribute the used windows.

When the different components of the window are made of plastic, they can be disposed of as burnable refuse or be recycled for new productions.

A window frame of aluminium can bring in a relatively high price as aluminium waste.

The embodiments of the window according to the invention described above and shown in the drawing are only to be taken as examples, many other embodiments being possible within the scope of the invention.

Thus, the above embodiments can advantageously be combined in different ways, the first part of the window frames for example being provided with both sealing lips and barbs at the same time.

The number of sealing lips and barbs need not be the number shown and described either but can be any appropriate number.

Correspondingly, the panes used in the windows need not be a flexible plastic sheeting either, they can be of any other kind of impermeable material in form of e.g. plastic, aluminium, or iron plates.

The window according to the invention is not just well suited for temporarily closing a window opening in a building under construction, the window can just as well be used for temporarily closing any kind of opening, such as openings for doors, and openings in buildings that are to be renovated or that have been damaged by e.g. storm.

Furthermore, the wall openings and windows need not be quadrangular either but can have any other kind of geometric shape.

What is claimed is:

1. A closure for temporarily closing an opening in a wall of a building comprising:
a closure frame for detachable mounting in a wall opening having an exterior and an inside face which define a gap therebetween,
a first plate-shaped part on the closure frame and extending, in a mounted state of this closure frame, along the inside face of the wall opening at a selected distance therefrom,
a second plate-shaped part on the closure frame and extending, in the mounted state of this closure frame, outward along one side of the wall,
at least one cover for mounting on the closure frame,
means for fastening the closure frame in the opening, and
at least one elastically bendable flap placed crosswise on the first part of the closure frame, wherein the flap extends along an outer side of the part and having, in an unloaded state, a height that is greater than the gap between the exterior and the inside face of the wall opening.

2. The closure of claim 1, wherein the at least one elastically bendable flap on the first part of the closure frame is arranged to incline crosswise toward the second part.

3. The closure of claim 2, wherein at least one elastically bendable flap has a free edge area which is made with a bend.

4. The closure of claim 1, wherein the first part includes at least one longitudinal, rigid rib on its outwards facing side, and at least one sealing rib that is longer than the rigid rib(s).

5. The closure of claim 1, wherein the second part includes at least one longitudinal sealing lip on its inwards facing side.

6. The closure of claim 1, wherein the means for fastening the closure frame comprises at least one longitudinal barb on the first part on its outwards facing side.

7. The closure of claim 6, wherein the means for fastening the closure frame further comprises a longitudinal catch made on a free edge of the first part and extending in the same direction as the second part at a distance mainly corresponding to the thickness of the wall.

8. The closure of claim 6, wherein the means for fastening the closure frame further comprises:
at least one strap having a first end part made on or fastened to the closure frame,
a second end part provided with at least one barb oriented with the point pointing in the opposite direction of the first side of the wall,
at least one cross member which is bearing against the second side of the wall in the mounted position of the closure, and
at least one hole made in the cross member, whereby this hole and the second end part of the strap are arranged in such a way that the end part can be guided in through the hole in a direction from the first to the second side of the wall, but are prevented from being taken in the opposite direction by an engagement between the at least one barb of the second end part and a peripheral area around the hole on the back of the cross member.

9. The closure of claim 6, wherein the means for fastening the closure frame comprises:
a support frame bearing against the second side of the wall in the mounted position of the closure,
at least one strap having a first end part made on or fastened to the support frame, and a second end part in form of a fork,
at least one barb made in the fork and the point of which is pointing towards the first side of the wall, and
at least one extension made on the first part of the closure frame of the closure and having a longitudinal barb the point of which is pointing in the opposite direction of the first side of the wall,
whereby the extension and the fork are arranged in such a way that the extension can be guided into the fork but is prevented from being taken out again by an engagement between the barb of the extension and the at least one barb of the fork.

10. The closure of claim 1, wherein the cover is at least one layer of plastic sheeting.

11. The closure of claim 10, wherein that the at least one layer of sheeting is transparent and reinforced by filaments.

12. A closure for temporarily closing an opening in a wall in a building comprising:
a closure frame for detachable mounting in a wall opening having an exterior and an inside face which define a gap therebetween,
a first plate-shaped part on the closure frame and extending along the inside face of the wall opening at a distance from this face in the mounted position of the closure frame,
a second plate-shaped part made on the closure frame and extending outwards along a side of the wall in the mounted position of the closure frame,
at least one flexible cloth for mounting on the closure frame,
at least one elastically bendable flap placed crosswise on the first part of the closure frame, with the flap extending along an exterior of the first part and having a height greater than the gap between the exterior and the inside face of the wall opening in unloaded state, and
a clamping frame that includes a number of loose or joined bars that serve to fix the at least one flexible cloth on the closure frame.

13. The closure of claim 12, wherein that the at least one elastically bendable flap on the first part of the closure frame is arranged to incline crosswise in a direction towards the second part.

14. The closure of claim 13, wherein the at least one elastically bendable flap has a free edge area which is shaped with a bend.

15. The closure of claim 13, wherein the at least one elastically bendable flap on the first part of the closure frame is arranged to incline crosswise in a direction towards its second part.

16. The closure of claim 12, wherein the clamping frame has a cross section that is shaped as a U with the U having legs which terminate at ends, the closure frame includes longitudinal grooves for receiving the ends of the legs of the U, and the peripheral area of the flexible cloth is squeezed together between at least one of the legs of the U and one of the grooves.

17. The closure of claim 16, wherein the clamping frame is fixed onto the closure frame by screws.

18. The closure of claim 12, wherein the clamping frame has a first contact face and the closure frame has a second contact face having a complementary shape to the first contact face, and a flexible cloth is fastened between the two contact faces.

19. The closure of claim 18, wherein two flexible cloths are kept at a mutual distance by the clamping frame, and both cloths are fastened between the two contact faces.

20. The closure of claim 18, which further comprises clamps arranged to be fastened on the closure frame to fix the clamping frame in towards the first contact face of the closure frame.

21. The closure of claim 20, wherein each clamp is shaped as a chair, the chair has legs for being pressed into grooves of a complementary shape in the first part of the closure frame, the chair has a back for bearing against the clamping frame, and the chair has a seat for absorbing a pressure for pressing the legs of the chair into the grooves of a complementary shape in the first part of the closure frame.

22. The closure of claim 16, wherein the clamping frame is made of a pipe.

23. The closure of claim 22, wherein the pipe is round.

24. The closure of claim 23, wherein the pipe is rectangular.

25. The closure of claim 18, wherein the first contact face of the closure frame includes an inside face of a groove made in the closure frame, and the rectangular pipe has a contact face made of an outer side of a projection of a complementary shape on the rectangular pipe.

26. The closure of claim 18, wherein the second part of the closure frame and the side of the wall opening form a gap, and that a sealing ring is placed in this gap.

27. The closure of claim 18, wherein the first part of the closure frame includes a handle for manually drawing the closure frame into the wall opening from the inside of the wall.

28. The closure of claim 12, wherein the means for fastening the closure frame in the wall opening are screws that are screwed into the inside of the wall opening via the first part.

29. The closure according to claim 12, wherein the flexible cloth is at least one layer of plastic sheeting.

30. The closure of claim 29, wherein the plastic sheeting is transparent and reinforced by filaments.

31. A closure for temporarily closing an opening in a wall in a building comprising:
a closure frame for detachable mounting in a wall opening having an exterior and an inside face which define a gap therebetween,
a first plate-shaped part made on the closure frame and extending in along the inside face of the wall opening at a distance from this face in the mounted state of the closure frame,
a second plate-shaped part made on the closure frame and extending outwards along one side of the wall in the mounted state of the closure frame,
at least one flexible cloth for mounting on the closure frame,
at least one elastic sealing element placed on the first part of the closure frame, extending along an exterior of the first part and having a height greater than the gap between the exterior and the inside face of the wall opening in unloaded state, and
a clamping frame of loose or joined bars that serve for fixing the at least one flexible cloth on the closure frame.

32. The closure of claim 31, wherein the elastic sealing element is shaped as a sealing lip made of an elastic material.

33. The closure of claim 31, wherein the elastic sealing element is shaped from an elastically compressible material.

34. The closure of claim 31, wherein the clamping frame has a first contact face and the closure frame has a second contact face of a complementary shape, two flexible cloths are provided and kept at a mutual distance by the clamping frame, and both cloths are fastened between the two contact faces.

35. The closure of claim 34, which further comprises a number of clamps arranged to be fastened on the closure frame for clamping the clamping frame in towards the first contact face of the closure frame.

36. The closure of claim 31, wherein the clamping frame is made of pipe.
